(19) United States
(12) Patent Application Publication
(10) Pub. No.: US 2009/0250452 A1
(43) Pub. Date: Oct. 8, 2009

(54) Steam Convection Oven

(76) Inventor: Sze-Man Tse, Hong Kong (CN)

Correspondence Address: LAW OFFICES OF RAYMOND A. NUZZO, LLC, 579 THOMPSON AVENUE, EAST HAVEN, CT, 06512, US

(21) Appl. No.: 12/375,600

(22) PCT Filed: Aug. 7, 2007
(86) PCT No.: PCT/CN07/02361

§ 371 Date: Feb. 16, 2009

Related U.S. Application Data
(60) Provisional application No. 60/821,743, filed on Aug. 8, 2006.

(51) Int. Cl. A21B 1/24; A21B 1/22; F22B 1/28; H05B 1/02; F24C 15/00

(52) U.S. Cl. 219/401; 219/400; 392/394; 219/494; 126/20; 126/21 A

(57) ABSTRACT

A steam convection oven (10) has a cooking chamber (14) that has an exterior side (15) and an opening for the introduction of steam into the cooking chamber (14). The steam convection oven (10) also has a water reservoir (30) and a steam generator (60) fluidly connected to the water reservoir (30). The steam generator (60) has a steam outlet and converts water from the water reservoir (30) to steam. A steam distribution network is connected to the steam outlet and the opening in the cooking chamber (14) so as to introduce steam into the cooking chamber (14). The steam distribution network has at least one steam inlet device that is connected to the exterior side (15) of the cooking chamber (14) and which is in communication with the opening in the cooking chamber (14). Electronic control circuitry (82) configures the steam convection oven (10) in one of a plurality of cooking modes and provides electrical power to components of the steam convection oven (10). The steam convection oven (10) also has a fan system (102) that has a first fan that operates only in predetermined cooking modes to create air convection within the cooking chamber (14) and to accelerate the rate at which steam flows into the cooking chamber (14). The fan system (102) includes a second fan that operates only when the first fan operates and cools the oven's components. The steam convection oven (10) has a pump (232) that pumps water from the water reservoir (30) to the steam generator (60).

### TECHNICAL FIELD

The present invention generally relates to steam ovens.

### BACKGROUND ART

Steam ovens are used to cook, heat or re-heat foods by steaming. Food steaming is desirable because, when compared to other cooking techniques, such as boiling, it reduces the amount of essential vitamins and minerals that are removed from the food during cooking. Steam ovens are described in U.S. Pat. Nos. 4,724,824, 5,515,773, 5,865,108 and 6,992,268 and U.S. Patent Application Publication No. US2005/0066959.

### DISCLOSURE OF THE INVENTION

Accordingly, it is an object of the present invention to provide a steam convection oven.

It is another object of the present invention that the aforesaid steam convection oven can be manufactured at a reasonable per-unit cost.

Thus, the present invention is directed to a steam convection oven. In a preferred embodiment, the steam convection oven comprises a cooking chamber that has an exterior side and an opening for the introduction of steam into the cooking chamber. The steam convection oven further comprises a water reservoir and a steam generator that is fluidly connected to the water reservoir. The steam generator converts water from the water reservoir to steam. The steam generator includes a steam outlet. A steam distribution network is connected to the steam outlet and the opening in the cooking chamber to introduce steam into the cooking chamber. The steam distribution network comprises at least one steam inlet device that is connected to the exterior side of the cooking chamber and which is in communication with the opening in the cooking chamber. The steam convention oven further comprises electronic control circuitry that configures the steam convection oven in one of a plurality of cooking modes and provides electrical power to components of the steam convention oven. The steam convention oven further includes a fan system. The fan system comprises a first fan that operates only in predetermined cooking modes to create air convection within the cooking chamber and to accelerate the rate at which steam flows into the cooking chamber. The fan system further comprises a second fan that operates only when the first fan is operating and cools the components of the steam convention oven. The steam convection oven further comprises an electrically activated pump that pumps water from the water reservoir to the steam generator.

In another embodiment, the steam convection oven generally comprises a cooking chamber, a steam generator to convert water to steam, and a steam distribution network to introduce steam to the cooking chamber. The steam generator has a steam outlet through which steam exits the steam generator. The steam distribution network is in communication with the steam outlet of the steam generator and the cooking chamber. The steam distribution network comprises a pair of steam inlet devices in communication the cooking chamber. Each steam inlet device is located at an opposite end of the cooking chamber in order to allow equal amounts of steam to enter opposite ends of the cooking chamber. Thus, steam exits the steam outlet of the steam generator and passes through the steam distribution network and the steam inlet devices and into the cooking chamber. The steam convection oven has control circuitry to activate the steam convection oven in one of a plurality of cooking modes and to provide electrical power to the steam generator and other components of the oven. The steam convection oven further comprises a fan system that has first and second fan systems. The first fan system creates air convection within the cooking chamber and accelerates the rate at which steam flows into the cooking chamber. The first fan system operates only during predetermined cooking modes. The second fan system operates only when the first fan system is operating and cools the oven's components. A water tank holds the water which is eventually converted to steam.

Other objects of the present invention, as well as particular features, elements and advantages thereof, will be elucidated in, or be apparent from, the following description and the accompanying drawing figures.

### BRIEF DESCRIPTION OF THE DRAWINGS

Understanding of the present invention and the various aspects thereof will be facilitated by reference to the accompanying drawing figures, submitted for the purposes of illustration only and not intended to define the scope of the invention, in which:

FIG. 1 is a front view of a steam convection oven in accordance with one embodiment of the present invention;

FIG. 2 is a rear view, in perspective, of the steam convection oven of FIG. 1, the outer housing of the steam convection oven not being shown so as to facilitate viewing of the exterior side of the rear wall of the cooking chamber and the steam generator attached to this exterior side;

FIG. 3 is an exploded view of a water tank system, steam generator and steam distribution network depicted in FIG. 1;

FIG. 4 is a rear view, in perspective, similar to the view of FIG. 2, showing a fan system used to create air convection and to cool oven components;

FIG. 5 is a perspective view of the steam convection oven of FIG. 1, the view showing the front and a side of the steam convection oven and the outer housing;

FIG. 6 is a perspective view of the water tank system, steam generator and steam distribution network, previously depicted in FIG. 3, completely assembled;

FIG. 7 is a rear view, in perspective, of a steam convection oven in accordance with another embodiment of the present invention;

FIG. 8 is an enlarged view of a water tank, a water pump assembly, a steam generator and a steam inlet device shown in FIG. 7;

FIG. 9 is an exploded view of the components comprising the water tank, water pump assembly, steam generator and steam inlet device shown in FIG. 8; and

FIG. 10 is a perspective view, further enlarged, of the water tank and water pump assembly shown in FIG. 8.

### BEST MODE FOR CARRYING OUT THE INVENTION

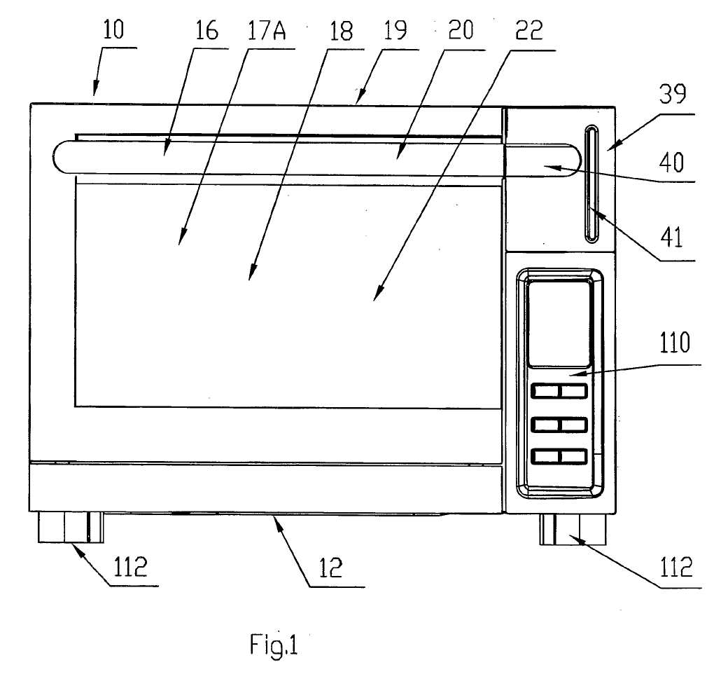

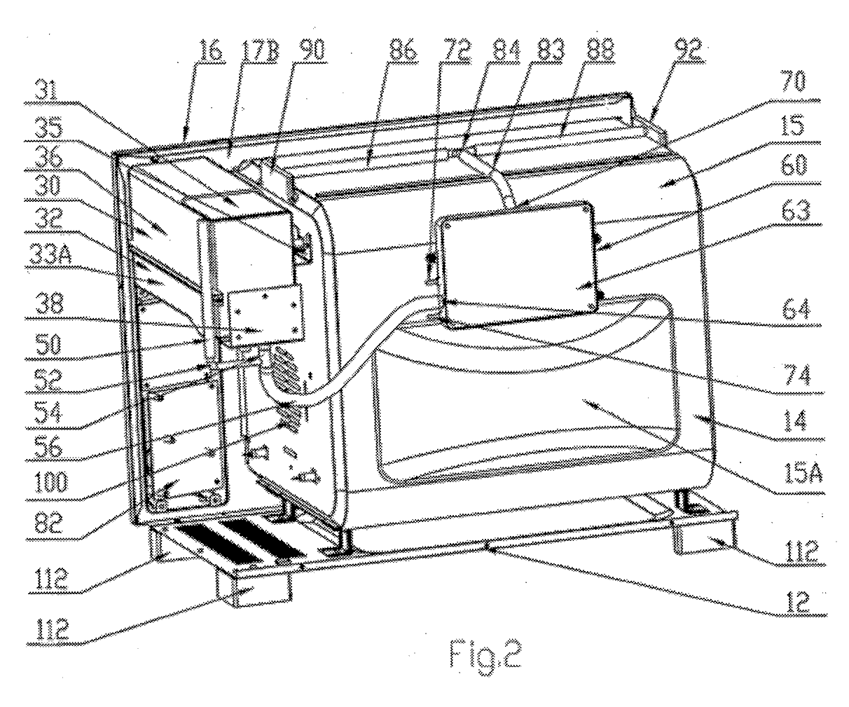

Referring to FIGS. 1 and 2, there is shown steam convection oven 10 in accordance with one embodiment of the present invention. Steam convection oven 10 generally comprises base 12 and cooking chamber 14 that is mounted or attached to base 12. Steaming and cooking of foods occurs in cooking chamber 14. Cooking chamber 14 has exterior side 15. Cooking chamber 14 also has protruding or bulging portion 15A which functions to enlarge the interior of cooking chamber 14.

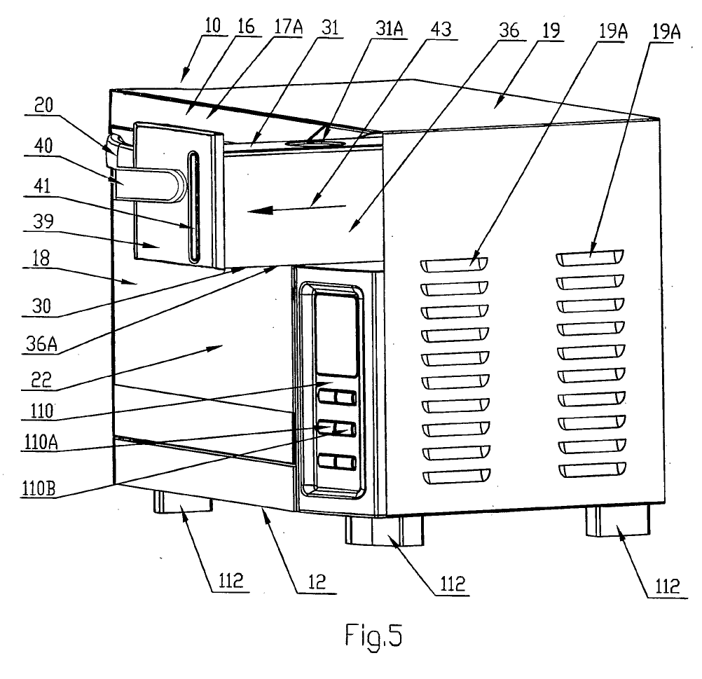

Steam convection oven 10 further comprises front panel assembly 16 having a front or exterior side 17A and rear or interior side 17B. Front panel assembly 16 includes door 18. Door 18, when opened, allows access to the interior of cooking chamber 14. The interior of cooking chamber 14 is sized to receive at least one food tray (not shown). Such food trays are known in the art and therefore, not discussed in detail. Door 18 includes handle 20, and a latch mechanism, not shown, for releasably closing door 18. Door 18 comprises glass member 22 to allow viewing the interior of cooking chamber 14 while door 18 is closed. Door 18 is seated around its periphery to prevent the dripping of condensation from the interior of cooking chamber 14. Steam convection oven 10 has outer housing 19 that covers the entire cooking chamber 14 and the remaining interior of steam convection oven 10 (see FIG. 5). Outer housing 19 is removably attached to base 12 and interior side 17B of front panel assembly 16. Outer housing 19 insulates the surrounding outside environment, including the user of the steam convection oven 10, from the heat within cooking chamber 14. As shown in FIG. 5, outer housing 19 includes a plurality of vents 19A to vent the heat within outer housing 19.

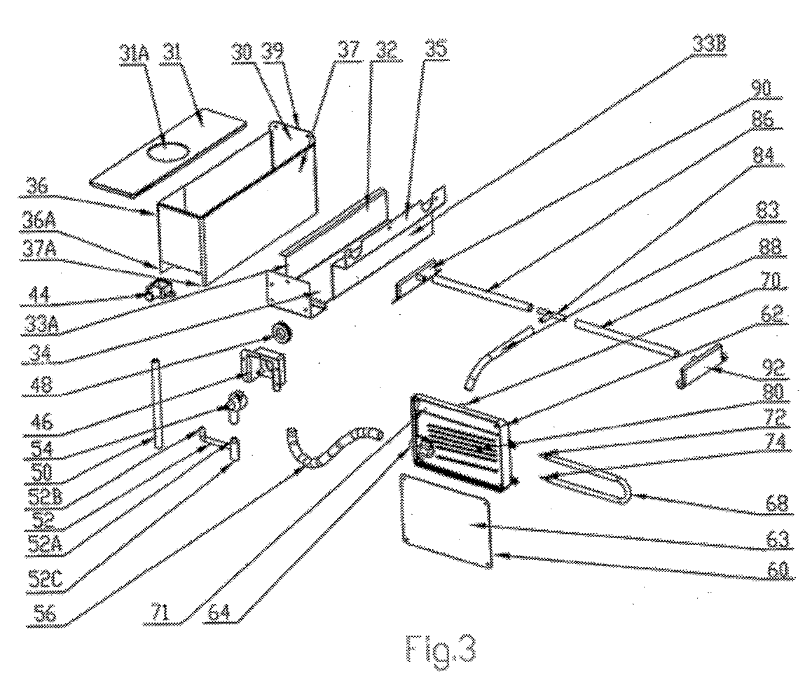

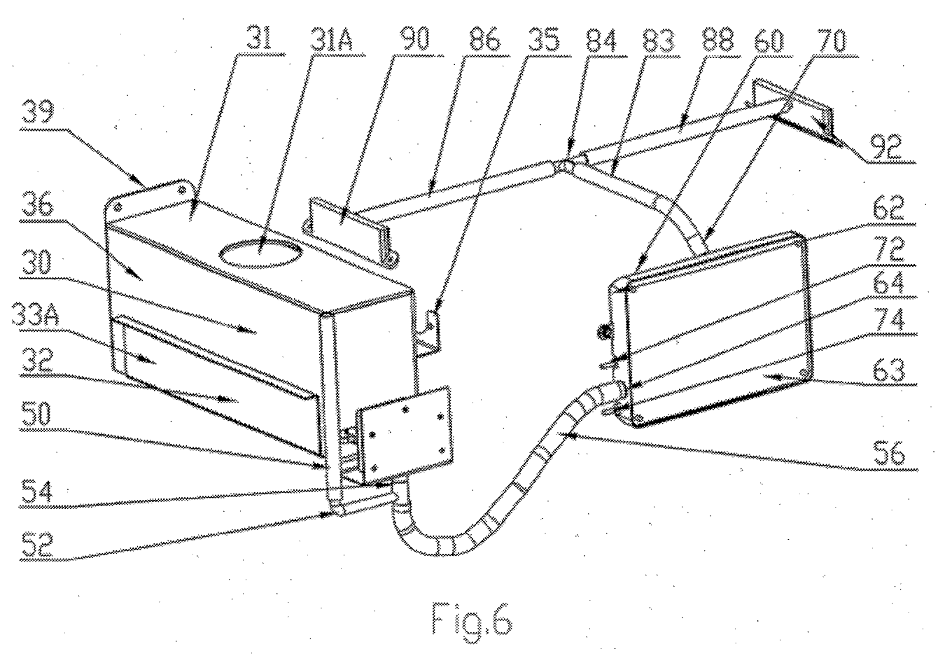

Referring to FIGS. 2, 3, 5 and 6, in one embodiment, steam convection oven 10 further comprises a water tank assembly that generally comprises water tank 30 and water tank cover 31. Water tank cover 31 includes opening 31A for refilling water tank 30. The aforesaid water tank assembly includes water tank holder 32. Water tank holder 32 includes sidewalls 33A and 33B, bottom 34, and mounting section 35. As shown in FIG. 2, mounting section 35 is attached to exterior side 15 of cooking chamber 14. Water tank 30 comprises sidewall 36 which has bottom edge portion 36A. Water tank 30 further includes sidewall 37 which has bottom edge portion 37A. Water tank 30 includes a bottom (not shown) and front panel 39 (see FIGS. 3 and 5). Front panel 39 includes handle 40 and built-in water level indicator 41. Water level indicator 41 allows the user to view the level of water in water tank 30. Water tank 30 can move with respect to water tank holder 32. Bottom edges 36A and 37A of water tank 30 slide upon the bottom 34 of water tank holder 32 when water tank 30 is moved with respect to water tank holder 32. As shown in FIG. 5, the user can use handle 40 to pull water tank 30 outward in the direction indicated by arrow 43. When water tank 30 is pulled outward, opening 31A is exposed which allows the user to refill water tank 30. As shown in FIGS. 2 and 6, the water flows from water tank 30 by means of gravity and not by electromechanical means or pumping devices.

Referring to FIGS. 2, 3 and 6, steam convection oven 10 further includes a water distribution system that comprises water outlet 44, water outlet mount 46, annular seat member 48, water conduit sections 50, 52 and 54 and water hose 56 (see FIG. 3). Water outlet 44 is fluidly connected to water conduit section 54. Portion 52A of water conduit section 52 is fluidly connected water conduit section 54. Portion 52B of water conduit section 52 is fluidly connected to water conduit section 50. Hose 56 is fluidly connected to portion 52C of water conduit section 52. Water conduit section 50 functions as a water-overflow conduit and wilt hold a predetermined amount of overflow. Steam convection oven 10 further comprises a steam generator, generally indicated by reference number 60. Steam generator 60 comprises housing 62, cover 63, water inlet 64, heating element 68, and steam outlet 70. The water distribution system allows water from water tank 30 to flow through water hose 56 which is connected to water inlet 64. Thus, the water in water hose 56 flows into housing 62 of steam generator 60. Housing 62 has rear wall 71. In one embodiment, heating element 68 is generally U-shaped. However, heating element 68 may be configured to have other suitable shapes. Heating element 68 has electrical connectors 72 and 74 for connection to electrical control circuitry 82 (see FIG. 2) via electrical wires (not shown). When electrical power is applied to heating element 68, heating element 68 becomes very hot. Housing 62 has a plurality of ribs or ridges 80 on rear wall 71. Ribs or ridges 80 extend laterally and are spaced apart, one above the other. In a preferred embodiment, ribs or ridges 80 are slightly slanted. Ribs or ridges 80 prevent boiling water from seeping into steam outlet 70. The slanted orientation of ribs 80 allows the boiling water to run off of the ribs 80. Heating element 68, when electrical power is applied thereto, heats up the water in housing 62 so that it starts to boil and create steam. The steam produced by the boiling water exits housing 62 via steam outlet 70.

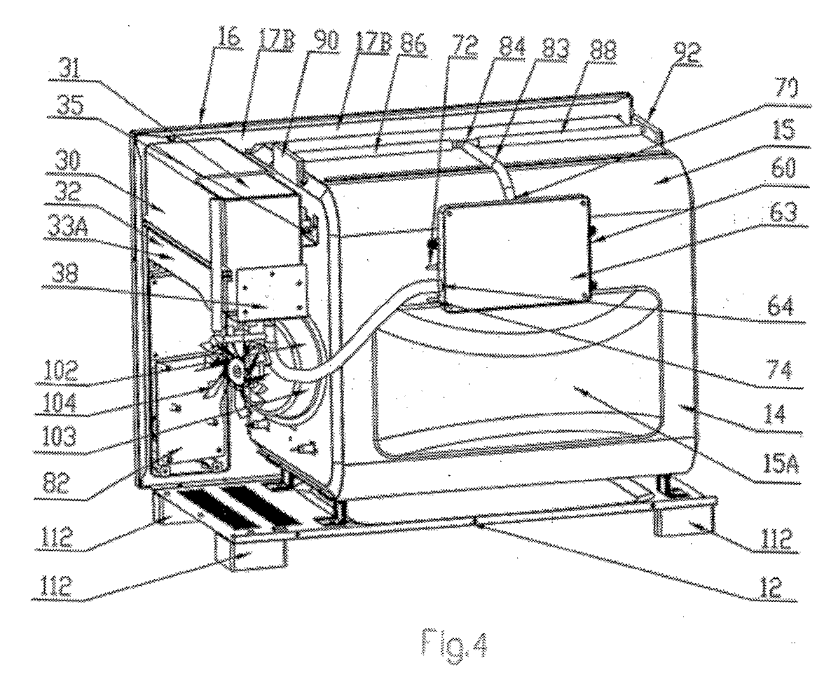

Referring to FIGS. 2 and 4, steam convection oven 10 further comprises a steam distribution network that comprises steam conduit 83, which is connected to steam outlet 70 of steam generator 60, “T” connector 84, and steam conduits 86 and 88 which are connected to “T” connector 84. Steam conduits 86 and 88 are in fluid communication with steam inlet devices 90 and 92, respectively, which are attached to the top portion of exterior side 15 of cooking chamber 14. Steam inlet devices 90 and 92 are located at opposite ends of cooking chamber 14 and are in communication with cooking chamber 14. Thus, steam exits steam generator 60 via steam outlet 70 and flows through steam conduit 83, “T” connector 84, steam conduits 86 and 88, through steam inlet devices 90 and 92 and into cooking chamber 14. The dual steam inlet devices 90 and 92, and their predetermined locations, ensure that equal amounts of steam enter opposite ends of cooking chamber 14. This ensures the food is cooked uniformly. Alternately, the steam inlet devices can be located on the sides of cooking chamber 14, or on the rear side of cooking chamber 14 (i.e. adjacent steam generator 60), or on the bottom of cooking chamber 14.

Referring to FIGS. 2 and 4, in a preferred embodiment, cooking chamber 14 has a plurality of vent slots 100 in the side thereof and steam convection oven 10 further comprises a fan system 102 (see FIG. 4). Fan system 102 comprises housing 103 that contains an internal fan. Housing 103 is mounted to exterior side 15 of cooking chamber 14 so that the internal fan confronts slots 100. When the internal fan is operating, it creates air convection within cooking chamber 14 and accelerates the rate at which steam flows from the steam inlet devices 90 and 92 and into cooking chamber 14. Thus, the internal fan decreases the cooking time.

The steam convection oven 10 is configured to operate in any one of a plurality of cooking modes. The plurality of cooking modes includes, but is not limited to, (a) Steam and Convection Bake Mode, (b) Convection Bake Mode, (c) Defrost Mode, (d) Dehydrate Mode, and (e) Steam Bake Mode. In a preferred embodiment, the internal fan of fan system 102 operates only in Steam and Convection Bake Mode and in Convection Bake Mode. Although five cooking modes have been mentioned above, it is to be understood that there can be more than five cooking modes.

Fan system 102 further includes external fan 104 which vents heat from outer housing 19 in order to keep the oven's components cool. In a preferred embodiment, external fan 104 operates only when the internal fan is operating.

Referring to FIG. 1, steam convection oven 10 includes control panel 110 that is electrically connected to electrical control circuitry 82. Electrical control circuitry 82 provides electrical power to the components of steam convention oven 10 such as steam generator 60 and fan system 102. Electrical control circuitry 82 receives electrical voltage and current via a wire or power cord (not shown) that is connected to a power source such as an A.C. receptacle found in most homes. Control panel 110 also allows the user to configure steam convection oven 10 in any of the foregoing modes of operation. Electrical control circuitry 82 includes programmable circuitry, such as a microprocessor, that has data stored therein which pertains to each cooking mode such as time duration, whether air convection is to be used, etc. Thus, each cooking mode has a corresponding predetermined time duration associated therewith. Upon expiration of the predetermined time duration, the cooking mode terminates and steam convection oven 10 automatically shuts off.

Prior to operation of oven 10, the user grasps handle 40 and pulls water tank 30 outward. The user then adds water to water tank 30 via opening 31A in water tank cover 31. The user then pushes upon handle 40 in order to slide water tank 30 back into outer housing 19. Gravity will cause the water to flow through water outlet 44, conduits 52 and 54, and water hose 56 and into steam generator 60. When the user is ready to operate steam convection oven 10, the user opens door 18 and inserts dishes or trays of food into the interior of cooking chamber 14. Control panel 110 includes a plurality of buttons, including “Start” button 110A and “Stop” button 110B, both of which being electrically connected to electrical control circuitry 82. The user uses the appropriate buttons on control panel 110 to select a desired cooking mode and then activates oven 10 using “Start” button 110A (see FIG. 1). Electrical power is then applied to heating element 68 in steam generator 60 which causes the water in steam generator 60 to boil so as to create steam. The steam will flow through steam outlet 70, conduit 83, “T” connector 84, steam conduits 86 and 88, steam inlet devices 90 and 92 and into cooking chamber 14. If the user selects “Steam and Convection Bake Mode” or “Convection Bake Mode”, the internal fan (within housing 103) of fan system 102 operates to create air convection. Electrical control circuitry 82 terminates operation when the predetermined time duration for the selected cooking mode expires. The user can also stop operation of oven 10 by pressing the “Stop” button 110B.

Referring to FIGS. 1, 2 and 4, steam convection oven 10 further includes contact members 112 which are connected to base 12. Contact members 112 physically contact the surface, such as a table or countertop, upon which steam convection oven 10 is positioned.

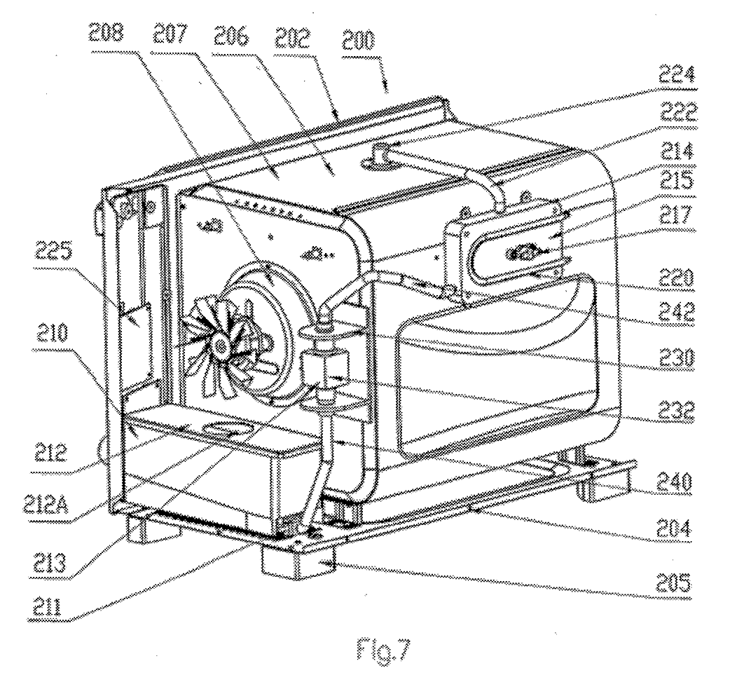

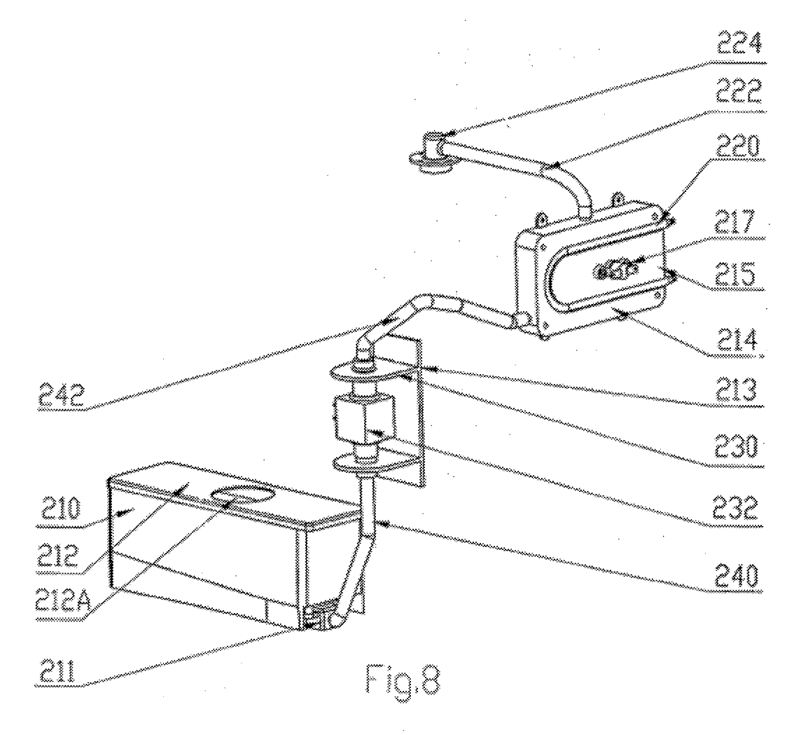

Referring to FIGS. 7 and 8, there is shown steam convection oven 200 in accordance with another embodiment of the present invention. Steam convection oven 200 generally comprises front frame assembly 202, base 204, and cooking chamber 206. Cooking chamber 206 has a top portion 207. Steam convection oven 200 further includes fan system 208. Fan system 208 has generally the same configuration and function as fan system 102 used in steam convection oven 10 and thus, comprises an internal fan and external fan. Front frame assembly 202 is attached to the base 204 and to the front of cooking chamber 206. Cooking chamber 206 has the same function as cooking chamber 14 of steam convection oven 10. Contact members 205 are connected to the bottom of base 204 and provide the same function as contact members 112 (see FIG. 4).

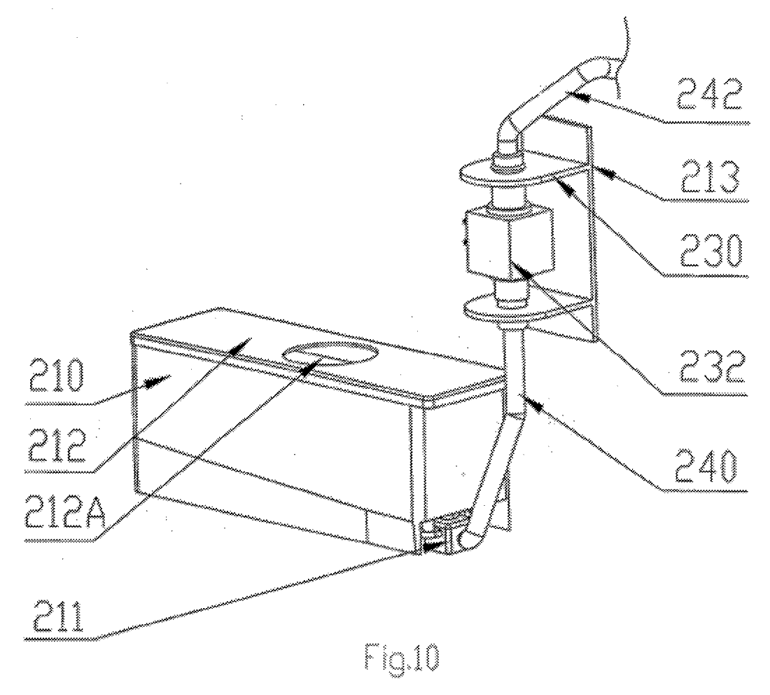

As shown in FIGS. 7-10, steam convection oven 200 further comprises water tank 210. Water tank 210 includes water outlet device 211 through which water exits water tank 210. Cover 212 covers water tank 210. Water tank cover 212 has opening 212A to allow water to be added to water tank 210. Water tank 210 has a handle (not shown) that allows a user to pull the water tank 210 outward so that water may be added through opening 212A. Water tank 210 and water tank cover 212 have generally the same structure and purpose as water tank 30 and water tank cover 31, respectively, of steam convection oven 10. Water tank 210 is mounted upon base 204. Steam convection oven 200 further comprises water pump assembly 213 and steam generator 214. Water pump assembly 213 comprises electrically controlled water pump 232 that, when activated, pumps water from water tank 210 to steam generator 214. Water pump assembly 213 is described in detail in the ensuing description. Steam generator 214 has a housing 215 and cover 216. Steam generator 214 performs generally the same function as steam generator 60 of steam convection oven 10. Steam convection oven 214 includes a temperature switch 217 that is mounted to housing 215. Steam generator 214 includes heating element 220 that performs generally the same function as heating element 68 (see FIG. 3). Temperature switch 217 shuts off electrical power to heating element 220 when the temperature of heating element 220 reaches a predetermined temperature. The exterior side of housing 215 has a grove or channel 215A that is shaped and sized to receive heating element 220. In one embodiment, heating element 220 has a generally “U” shape for uniform heat distribution. However, heating element 220 may be configured to have other suitable shapes. Steam generator 214 includes a steam outlet to which steam conduit 222 is connected. A single steam inlet device 224 is connected to steam conduit 222 and is in communication with the interior of cooking chamber 206. As can be seen in FIG. 7, steam inlet device 224 is centrally located on top portion 207 of cooking chamber 206. Thus, only one steam inlet 224 is used to introduce steam into cooking chamber 206, whereas in steam convection oven 10 (FIGS. 2 and 4), two steam inlet devices 90 and 92 introduce steam into cooking chamber 14 from the left and right sides of the cooking chamber.

Referring FIGS. 7-10, water pump assembly 213 includes a mounting bracket 230 that is attached to the exterior of cooking chamber 206 and has holes 231 therein. Electrically controlled pump 232 has fluid inlet 234 and fluid outlet 236. Water pump 232 is mounted to mounting bracket 230 such that fluid inlet 234 and fluid outlet 236 are disposed through holes 231 of mounting bracket 230. Water pump assembly 213 further comprises fluid conduit sections 240 and 242. Fluid conduit section 242 is fluidly connected between pump fluid outlet 236 and steam generator 214. Fluid conduit section 240 is fluidly connected between pump fluid inlet 234 and water outlet 211 on water tank 210.

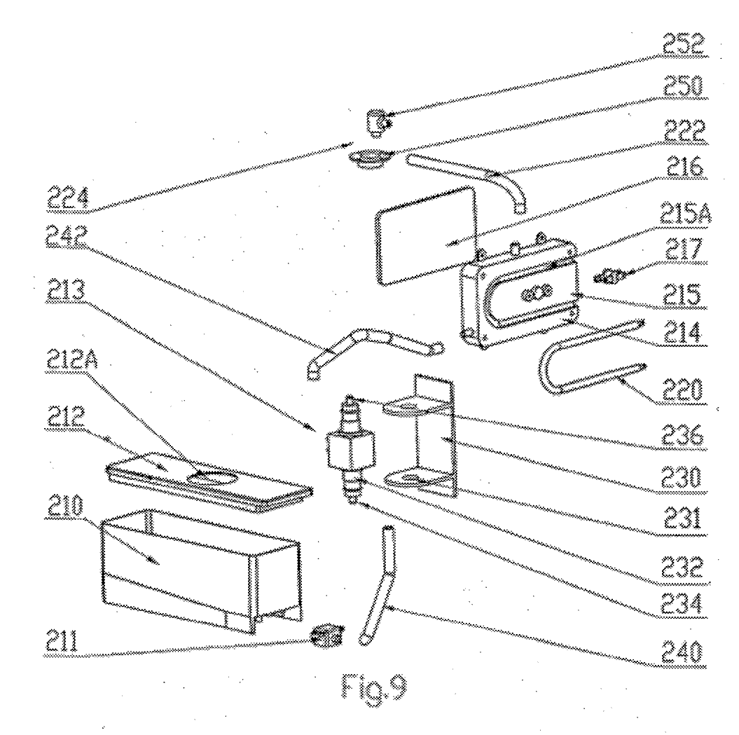

As shown in FIG. 9, steam inlet device 224 comprises fitting 250 and steam inlet 252. Fitting 250 is attached to top portion 207 of cooking chamber 206. Fitting 250 is disposed into a corresponding opening in cooking chamber 206. Steam inlet 252 is attached to fitting 250 and is in communication with steam conduit 222. Steam convection oven 200 can operate in any of the cooking modes in which steam convection oven 10 can operate. Steam convection oven 200 further includes electronic control circuit 225 (see FIG. 7) and a control panel (not shown) that controls the operation of steam convection oven 200, including pump 232. In a preferred embodiment, electronic control circuit 225 comprises programmable electronic circuitry such as a microprocessor. The amount of time during which water is pumped into steam generator 214 is controlled by the microprocessor. In one embodiment, the microprocessor is programmed so that pump 232 pumps water into steam generator 214 intermittently so that steam generator 214 generates steam intermittently. Thus, steam is intermittently introduced into cooking chamber 206.

It will thus be seen that the objects set forth above, among those elucidated in, or made apparent from, the preceding description, are efficiently attained and, since certain changes may be made in the above construction and/or method without departing from the scope of the invention, it is intended that all matter contained in the above description or shown in the accompanying drawing figures shall be interpreted as illustrative only and not in a limiting sense.

It is to be understood that steam convection oven 10 (see FIGS. 1-6) may be modified to use water pump assembly 213. It is also to be understood that steam convection oven 10 may be modified so that it uses only a single steam inlet on cooking chamber 14 in a manner similar to cooking chamber 206 (see FIG. 7).

It is also to be understood that the following claims are intended to cover all of the generic and specific features of the invention herein described and all statements of the scope of the invention which, as a matter of language, might be said to fall therebetween.

What is claimed is:

1. A steam convection oven, comprising:
a cooking chamber having an exterior side and an opening for the introduction of steam into the cooking chamber;
a water reservoir;
a steam generator fluidly connected to the water reservoir, said steam generator converting water from said water reservoir to steam, said steam generator having a steam outlet; and
a steam distribution network connected to said steam outlet and said opening in said cooking chamber to introduce steam into said cooking chamber.

2. The steam convection oven according to claim 1 wherein said steam distribution network comprises a steam inlet device attached to said exterior side of said cooking chamber and in communication with said opening in said cooking chamber.

3. The steam convection oven according to claim 1 wherein said cooking chamber has a plurality of openings therein for the introduction of steam into said cooking chamber, said steam distribution network comprising a plurality of steam inlet devices, each steam inlet device being connected to said exterior side of said cooking chamber and in communication with a corresponding one of said openings in said cooking chamber.

4. The steam convection oven according to claim 3 wherein said plurality of steam inlet devices comprises two steam inlet devices.

5. The steam oven according to claim 1 further comprising electrical control circuitry to configure said steam convection oven in one of a plurality of cooking modes and to provide electrical power to said steam generator.

6. The steam oven according to claim 1 further comprising a fan system that comprises a first fan that operates only in predetermined cooking modes to create air convection within said cooking chamber and to accelerate the rate at which steam flows into said cooking chamber.

7. The steam oven according to claim 6 wherein said fan system further comprises a second fan that is external to said cooking chamber and which operates only when said first fan is operating.

8. The steam convection oven according to claim 1 wherein said steam generator comprises:
a housing having an interior chamber for receiving water and generating steam from the water, said steam outlet being in communication with said interior chamber; and
a heating element in said interior chamber to heat the water to a boil.

9. The steam convection oven according to claim 8 wherein said housing of said steam generator has a rear wall that has an interior side confronting said interior chamber, said rear wall having on said interior side thereof a plurality of laterally extending ribs that are positioned one above another and spaced apart by a predetermined distance, said ribs preventing boiling water from exiting said steam outlet of said steam generator.

10. The steam convection oven according to claim 9 wherein said ribs are slightly slanted to allow boiling water to run off of said ribs.

11. The steam convection oven according to claim 1 wherein said water reservoir comprises a water tank.

12. The steam convection oven according to claim 11 further comprising a water conduit network fluidly connected to said water tank and said steam generator.

13. The steam convection oven according to claim 11 further comprising an outer housing section that houses said cooking chamber, said steam generator and said steam distribution network, and wherein said water tank is configured to be pulled outward from said outer housing section.

14. The steam oven according to claim 1 wherein said steam convection oven further comprises a pump for pumping water from said water reservoir to said steam generator.

15. A steam convection oven, comprising:
a cooking chamber having an exterior side and an opening for the introduction of steam into the cooking chamber;
a water reservoir;
a steam generator to convert water from said water reservoir to steam, said steam generator having a steam outlet;
an electrically activated pump device to pump water from said water reservoir to said steam generator;
a steam distribution network connected to said steam outlet and said opening in said cooking chamber to introduce steam into said cooking chamber, said steam distribution network comprising a single steam inlet device connected to said exterior side of said cooking chamber and in communication with said opening in said cooking chamber; and
electronic control circuitry to configure said steam convection oven in one of a plurality of cooking modes and to provide electrical power to said steam generator and said pump.

16. The steam convection oven according to claim 15 wherein said electronic control circuitry controls said pump so that it pumps a predetermined amount of water into said steam generator in accordance with a predetermined time schedule so as to enable said steam generator to generate steam intermittently.

17. The steam convection oven according to claim 15 further comprising a fan system that comprises a first fan that operates only in predetermined cooking modes to create air convection within said cooking chamber and to accelerate the rate at which steam flows into said cooking chamber.

18. The steam convection oven according to claim 17 wherein said fan system further comprises a second fan that is external to said cooking chamber and which operates only when said first fan is operating.

19. The steam convection oven according to claim 15 wherein said steam generator comprises:
a housing having an interior chamber for receiving water and generating steam from the water, said steam outlet being in communication with said interior chamber, the housing further including an exterior side that has a channel formed therein; and
a heating element disposed in said channel and configured to receive electrical power, said heating element heating the water to a boil when electrical power is applied to said heating element.

20. The steam convection oven according to claim 20 wherein the steam generator further comprises a temperature switch that shuts off electrical power to said heating element when the temperature of said heating element reaches a predetermined temperature.
